(19) United States
(12) Patent Application Publication
(10) Pub. No.: US 2008/0130157 A1
(43) Pub. Date: Jun. 5, 2008

(54) Recording Medium, Recording Apparatus And Method, Reproducing Apparatus And Method, And Computer Program

(75) Inventors: Takanori Maeda, Saitama (JP); Kiyoshi Tateishi, Saitama (JP); Atsushi Onoe, Saitama (JP); Kazuo Takahashi, Saitama (JP)

Correspondence Address: NIXON & VANDERHYE, PC, 901 NORTH GLEBE ROAD, 11TH FLOOR, ARLINGTON, VA, 22203, US

(73) Assignee: PIONEER CORPORATION, Meguro-ku, Tokyo (JP)

(21) Appl. No.: 11/667,727

(22) PCT Filed: Nov. 17, 2005
(86) PCT No.: PCT/JP2005/021106

§ 371 Date: Jun. 20, 2007

(30) Foreign Application Priority Data
Nov. 17, 2004 (JP) 2004-333231

(51) Int. Cl. G11B 15/18; G11B 5/82

(52) U.S. Cl. 360/71; 360/135

(57) ABSTRACT

A recording medium (100) on which record information is recorded, wherein the recording medium is displaced relatively with respect to a recording/reproducing device (60) for performing at least one of recording and reproduction of the record information, along each of one direction (X-axis) and another direction (Y-axis), and a track (120) which is a guide in recording the record information is formed such that a relative displacement direction of the recording/reproducing device due to the at least one of recording and reproduction of the record information is distributed substantially uniformly in both the one direction and the another direction.

### TECHNICAL FIELD

The present invention relates to a recording medium, such as a dielectric recording medium, a recording apparatus for and method of recording record information into such a recording medium, a reproducing apparatus for and method of reproducing the record information from such a recording medium, and a computer program which makes a computer function as such a recording apparatus and reproducing apparatus, for example.

### BACKGROUND ART

The inventors of the present invention has proposed a technology of a recording/reproducing apparatus using SNDM (Scanning Nonlinear Dielectric Microscopy) for nanoscale analysis of a dielectric recording medium. In the SNDM, it is possible to increase the resolution of measurement to sub-nanometer, by using an electrically conductive cantilever (or probe) having a small projection portion on its tip, which is used for atomic force microscopy (AFM) or the like. Recently, a super high-density recording/reproducing apparatus has been developed, wherein the apparatus records data into a recording medium having a recording layer made of a ferroelectric material by using the technology of SNDM (refer to a patent document 1).

On the recording/reproducing apparatus using such SNDM, the information is reproduced by detecting the positive/negative direction of polarization of the recording medium. This is performed by using the fact that the oscillation frequency of a LC oscillator, which includes a high-frequency feedback amplifier including a L component, the electrically conductive probe mounted on the amplifier, and the capacitance Cs of a ferroelectric material under the probe, is changed by a change ΔC in small capacitance, which is caused by the extent of a nonlinear dielectric constant caused by the distribution of the positive/negative polarization. Namely, this is performed by detecting a change in the distribution of the positive/negative polarization, as a change in oscillation frequency Δf.

Moreover, in order to detect the difference in the positive/negative polarization, by applying an alternating electric field to the oscillation frequency at sufficiently low frequency, the oscillation frequency changes with the alternating electric field. At the same time, a ratio of the change in the oscillation frequency, including a code or sign, is determined from the nonlinear dielectric constant of the ferroelectric material under the probe. Moreover, by FM (Frequency Modulation)-demodulating and extracting a component caused by the alternating electric field, from a high-frequency signal of the LC oscillator, which is FM-modulated in accordance with the change ΔC in the small capacitance associated with the application of the alternating electric field, the record information recorded in the ferroelectric recording medium is reproduced.

As the shape of the ferroelectric recording medium, for example, a planar shape is listed as one specific example. If data is recorded into the planar ferroelectric recording medium, the probe is displaced relatively with respect to the ferroelectric recording medium along two axes on the plane. For example, a patent document 2 discloses such a configuration that data is recorded or reproduced by displacing the probe in a planar manner along an X axis and a Y axis, which cross at right angles to each other. The patent document 2 discloses such a configuration that parallel tracks are formed on a recording medium and data is recorded and reproduced along the tracks. According to this disclosure, there are formed a plurality of tracks parallel to the Y axis, and a recording/reproducing apparatus records and reproduces the data along the tracks. Therefore, if this disclosure is applied to a dielectric recording medium, the probe is displaced along the X axis by a small distance corresponding to a track pitch after the data recording in one track is ended, and again, data is recorded and reproduced along a next track. That is, it is necessary to reciprocate the probe or the like along the Y axis many times.

### Patent document 1: Japanese Patent Application Laying Open NO. 2003-085969

### Patent document 2: Japanese Patent Application Laying Open NO. 2002-157746

### DISCLOSURE OF INVENTION

### Subject to be Solved by the Invention

As described above, if the data is recorded along the plurality of parallel tracks formed on the planar dielectric recording medium, the probe is disproportionately displaced in the Y-axis direction. Thus, a driving mechanism for displacing the probe in the Y-axis direction is overworked relatively, while a driving mechanism for displacing the probe in the X-axis direction is not used very often. Thus, the driving mechanism for displacing the probe in the Y-axis direction relatively tends to cause heat, and the heat cannot be smoothly radiated as the entire recording/reproducing apparatus. As a result, there is such a problem that its operations are unstable.

Moreover, since the probe is disproportionately displaced in the Y-axis direction, if the probe is displaced in contact with the dielectric recording medium, the directions of ablation and fatigue of the probe are also one-sided, which causes such a problem that the lifetime of the probe is reduced.

Moreover, if a data recording target is changed from one track to another track, the direction of acceleration provided to a recording/reproducing head is changed from the Y-axis direction to the X-axis direction, and furthermore, immediately after this, it is suddenly reversed from the X-axis direction to the Y-axis direction, so that unnecessary vibration or oscillation likely occurs on the recording/reproducing head. If this vibration matches the resonance frequency of the driving mechanisms and other components, resonance occurs as a whole, which causes such a problem that the operations of the recording/reproducing apparatus are remarkably unstable.

In order to solve the above-mentioned problems, it is therefore an object of the present invention to provide a recording medium, a recording apparatus and method, a reproducing apparatus and method, which enable data recording and reproduction to be stable, and a computer program which makes a computer function as such a recording apparatus and a reproducing apparatus.

### Means for Solving the Object

(Recording Medium)

The above object of the present invention can be achieved by a first recording medium on which record information is recorded, wherein the recording medium is displaced relatively with respect to a recording/reproducing device for performing at least one of recording and reproduction of the record information, along each of one direction and another direction different from the one direction, and on a recording surface of the recording medium, a track which is a guide in recording the record information is formed such that a relative displacement direction of the recording/reproducing device due to the at least one of recording and reproduction of the record information is distributed substantially uniformly in both the one direction and the another direction.

According to the first recording medium of the present invention, it is possible to record the record information including various content data, such as movies and music, or data for PC or the like. In the first recording medium, particularly, the track which is the guide in recording the record information is formed on the recording surface. Namely, the recording/reproducing device is relatively displaced along the track, to thereby record the record information. In particular, the track is formed on the recording surface such that the relative displacement direction of the recording/reproducing device due to the at least one of recording and reproduction of the record information is distributed substantially uniformly in both the one direction and the another direction. In other words, the track is formed on the recording surface such that the relative displacement direction of the recording/reproducing device due to the at least one of recording and reproduction of the record information is not biased toward either the one direction or the another direction.

Therefore, the relative displacement direction of the recording/reproducing device is not biased toward only the one direction or only the another direction. Thus, if the recording/reproducing device records and reproduces the record information in contact with the recording medium, the recording/reproducing device (particularly, the portion which is in contact with the recording medium) is abraded uniformly in both the one direction and the another direction, so that it is possible to relatively extend the lifetime of the recording/reproducing device.

In addition, both a driving mechanism for displacing the recording/reproducing device in the one direction and a driving mechanism for displacing the recording/reproducing device in the another direction operate at a uniform frequency or substantially uniform frequency. Therefore, it is possible to prevent such a disadvantage that one of the driving mechanisms goes wrong though the other does not. As a result, it is possible to extend the operation lifetime of a recording/reproducing apparatus provided with the recording/reproducing device. Moreover, since each of the driving mechanisms has substantially the same aspect of heat generation. Thus, it is possible to effectively prevent such disadvantages that the heat generation is focused on one of the driving mechanisms, resulting in bad heat radiation and that the operation of the recording/reproducing apparatus becomes unstable.

Moreover, it is possible to effectively prevent such a disadvantage that the displacement direction of the recording/reproducing device is suddenly changed. Thus, it is possible to reduce stress put on the recording/reproducing device. Therefore, it is possible to relatively prevent the damage of the recording/reproducing device, to thereby extend the lifetime of the recording/reproducing device. In addition, unnecessary vibration or oscillation does not occur or hardly occurs on the recording/reproducing device. Therefore, it is possible to effectively prevent such a disadvantage that resonance occurs as a whole because this vibration matches the resonance frequency of the driving mechanisms and other components, which makes the operations of the recording/reproducing apparatus remarkably unstable.

Consequently, according to the first recording medium of the present invention, it is possible to effectively prevent the various disadvantages, as described above, and thus it is possible to stably record the record information into the recording medium, and stably reproduce the record information recorded in the recording medium.

In one aspect of the first recording medium of the present invention, the track is formed such that a first partial track which extends in the one direction and a second partial track which extends in the another direction are alternately formed and such that a ratio of track lengths of the first partial track and the second partial track which are partially adjacent (e.g. which are continuous or connected, or which can be almost regarded as being continuous though another track is between them) is a predetermined value or less.

According to this aspect, if the ratio of the track lengths of the first partial track and the second partial track is the predetermined value or less (e.g. 20% or less, as described later), there is no significant difference between the track lengths of the first partial track and the second partial track. Therefore, the relative displacement of the recording/reproducing device is not biased toward only the one direction or only the another direction. Thus, it is possible to receive the above-mentioned various benefits.

In another aspect of the first recording medium of the present invention, the track is formed to have a third partial track which extends in a direction different from each of the one direction and the another direction between a first partial track which extends in the one direction and a second partial track which extends in the another direction and is partially adjacent to the first partial track.

According to the this aspect, due to the presence of the third partial track, the recording/reproducing device can be displaced on the track, more smoothly. Therefore, the relative displacement of the recording/reproducing device is hardly biased toward only the one direction or only the another direction, so that it is possible to receive the above-mentioned various benefits. In particular, stress put on the recording/reproducing device is not biased toward a single direction, so that it is possible to reduce the stress, more effectively.

In another aspect of the first recording medium of the present invention, track lengths of a first partial track which extends in the one direction and a second partial track which extends in the another direction and is partially adjacent to the first partial track are substantially the same.

According to this aspect, the relative displacement of the recording/reproducing device is not biased toward only the one direction or only the another direction. Thus, it is possible to receive the above-mentioned various benefits.

The above object of the present invention can be also achieved by a second recording medium on which record information is recorded, wherein on a recording surface of the recording medium, a track which is a guide in recording the record information is formed, and the track is formed such that a first partial track which extends in one direction and a second partial track which extends in another direction different from the one direction are alternately formed and such that a ratio of track lengths of the first partial track and the second partial track which are partially adjacent is a predetermined value or less.

According to the second recording medium of the present invention, it is also possible to record the record information as in the first recording medium. Moreover, as in the first recording medium, the track is formed on the recording surface.

Particularly in the second recording medium, the track is formed such that the first partial track and the second partial track are alternately formed. Moreover, the track is formed on the recording surface such that the ratio of the track lengths of the first partial track and the second partial track is the predetermined value or less. As described above, if the ratio of the track lengths of the first partial track and the second partial track is the predetermined value or less, there is no significant difference between the track lengths of the first partial track and the second partial track. Therefore, the relative displacement of the recording/reproducing device is not biased toward only the one direction or only the another direction. Thus, it is possible to receive the same various benefits as those of the first recording medium described above.

Incidentally, the “predetermined value” preferably specifies a more appropriate predetermined value, individually and specifically, on an experimental, experiential, mathematical, theoretical, or simulation basis, depending on the properties of a recording apparatus for recording the record information into the recording medium and the properties of a reproducing apparatus for reproducing the record information recorded in the recording medium. Moreover, the “predetermined value” herein is preferably equal to or less than the ratio of the track lengths of the first partial track and the second partial track, which can realize such a state that the relative displacement direction of the recording/reproducing device is not biased toward only the one direction or only the another direction (or the relative displacement direction of the recording/reproducing device is distributed, substantially uniformly, in both the one direction and the another direction).

In one aspect of the second recording medium of the present invention, the recording medium is displaced relatively with respect to a recording/reproducing device for performing at least one of recording and reproduction of the record information, along each of the one direction and the another direction.

According to this aspect, the relative displacement of the recording/reproducing device is not biased toward only the one direction or only the another direction. Thus, it is possible to receive the above-mentioned various benefits.

In an aspect of the recording medium that it is displaced relatively, as described above, the track may be formed such that a relative displacement direction of the recording/reproducing device due to the at least one of recording and reproduction of the record information is distributed substantially uniformly in both the one direction and the another direction.

By virtue of such construction, if the recording/reproducing device is relatively displaced along the track, the relative displacement of the recording/reproducing device is not biased toward only the one direction or only the another direction. Thus, it is possible to receive the above-mentioned various benefits.

In another aspect of the second recording medium of the present invention, the track is formed to have a third partial track which extends in a direction different from the one direction and the another direction between the first partial track and the second partial track.

According to the this aspect, due to the presence of the third partial track, the recording/reproducing device can be displaced on the track, more smoothly. Therefore, the relative displacement of the recording/reproducing device is hardly biased toward only the single direction, so that it is possible to receive the above-mentioned various benefits.

In another aspect of the second recording medium of the present invention, track lengths of the first partial track and the second partial track which are partially adjacent are substantially the same.

According to this aspect, the relative displacement of the recording/reproducing device is not biased toward only the one direction or only the another direction. Thus, it is possible to receive the above-mentioned various benefits.

In another aspect of the first or second recording medium of the present invention, the one direction and the another direction cross at right angles.

According to this aspect, it is possible to relatively easily form the track which is a target of the recording operation and the reproduction operation of a recording apparatus and reproducing apparatus (or recording/reproducing apparatus) with relatively simple structures of the driving mechanisms or the like.

In another aspect of the first or second recording medium of the present invention, one portion of the track and another portion other than the one portion do not cross each other.

According to this aspect, it is possible to relatively easily form such a track that the relative displacement of the recording/reproducing device is not biased toward only the one direction or only the another direction.

In another aspect of the first or second recording medium of the present invention, the track is spirally formed on the recording surface.

According to this aspect, it is possible to relatively easily form such a track that the relative displacement of the recording/reproducing device is not biased toward only the one direction or only the another direction.

In another aspect of the first or second recording medium of the present invention, a plurality of tracks are independently formed.

According to this aspect, it is possible to relatively easily form such a track that the relative displacement of the recording/reproducing device is not biased toward only the one direction or only the another direction.

In another aspect of the first recording medium on which the plurality of tracks are formed, as described above, at least one of the plurality of tracks independently formed may be a closed curve.

According to this aspect, it is possible to relatively easily form such a track that the relative displacement of the recording/reproducing device is not biased toward only the one direction or only the another direction.

The above object of the present invention can be also achieved by a third recording medium on which record information is recorded, wherein the recording medium is displaced relatively with respect to a recording/reproducing device for performing at least one of recording and reproduction of the record information, along each of one direction and another direction different from the one direction, and on a recording surface of the recording medium, the record information is recorded such that a relative displacement direction of the recording/reproducing device due to the at least one of recording and reproduction of the record information is distributed substantially uniformly in both the one direction and the another direction.

In order to solve the above-mentioned object, in the third recording medium of the present invention, the record information is recorded in the same aspect as that in the first recording medium, although the track is not formed. Therefore, if the record information is reproduced, the relative displacement of the recording/reproducing device is not biased toward only the one direction or only the another direction. Thus, according to the third recording medium of the present invention, as in the above-mentioned first recording medium, it is possible to stably record the record information into the recording medium, and stably reproduce the record information recorded in the recording medium.

Incidentally, in response to the various aspects of the first recording medium of the present invention described above, the third recording medium of the present invention can also adopt various aspects.

The above object of the present invention can be also achieved by a fourth recording medium on which record information is recorded, wherein the recording medium alternately has a first area in which the record information is recorded in one direction and a second area in which the record information is recorded in another direction different from the one direction, and a ratio of lengths of the first area and the second area which are partially adjacent is a predetermined value or less.

In order to solve the above-mentioned object, in the fourth recording medium of the present invention, the record information is recorded in the same aspect as that in the second recording medium, although the track is not formed. Namely, the first area corresponds to a recording area in which the first partial track is formed described above, while the second area corresponds to a recording area in which the second partial track is formed described above. Therefore, if the record information is reproduced, the relative displacement of the recording/reproducing device is not biased toward only the one direction or only the another direction. Thus, according to the fourth recording medium of the present invention, as in the above-mentioned second recording medium, it is possible to stably record the record information into the recording medium, and stably reproduce the record information recorded in the recording medium.

Incidentally, in response to the various aspects of the second recording medium of the present invention described above, the fourth recording medium of the present invention can also adopt various aspects.

(Recording Apparatus and Method)

The above object of the present invention can be also achieved by a first recording apparatus provided with: a recording device for recording record information into a recording medium; a displacing device for relatively displacing the recording device with respect to the recording medium, in one direction and another direction different from the one direction; and a controlling device for controlling the displacing device such that a relative displacement direction of the recording device due to the recording of the record information is distributed substantially uniformly in both the one direction and the another direction.

According to the first recording apparatus of the present invention, by virtue of the operation of the recording device, the record information is recorded into the recording medium. Then, in recording the record information, by virtue of the operation of the displacing device, the recording device is displaced relatively with respect to the recording medium.

Particularly in the first recording apparatus, by virtue of the operation of the controlling device, the operation of the displacing device is controlled so as to realize such a recording operation that the relative displacement direction of the recording device due to the recording of the record information is distributed substantially uniformly in both the one direction and the another direction. Thus, the relative displacement direction of the recording device due to the recording of the record information is not biased toward either the one direction or the another direction. By this, it is possible to receive the same various benefits as those of the first recording medium described above.

Incidentally, the first recording apparatus may record the record information into the recording medium in which the track is formed, like the above-mentioned first recording medium, or may record the record information into the recording medium in which the track is not formed, like the above-mentioned third recording medium. In any cases, by virtue of the operation of the controlling device, it is possible to receive the above-mentioned various benefits.

Incidentally, in response to the various aspects of the first or third recording medium of the present invention described above, the first recording apparatus of the present invention can also adopt various aspects.

The above object of the present invention can be also achieved by a second recording apparatus provided with: a recording device for recording record information into a recording medium; a displacing device for relatively displacing the recording device with respect to the recording medium, in one direction and another direction different from the one direction; and a controlling device for controlling the displacing device such that relative displacement of the recording device in the one direction and relative displacement of the recording device in the another direction are performed alternately and such that a ratio between a displacement amount of the relative displacement of the recording device in the one direction and a displacement amount of the relative displacement of the recording device in the another direction, which is performed subsequent to the relative displacement of the recording device in the one direction, is a predetermined ratio or less.

According to the second recording apparatus of the present invention, as in the first recording apparatus, by virtue of the operation of the recording device, the record information is recorded into the recording medium. Then, in recording the record information, by virtue of the operation of the displacing device, the recording device is displaced relatively with respect to the recording medium.

Particularly in the second recording apparatus, by virtue of the operation of the controlling device, the relative displacement of the recording device in the one direction and the relative displacement of the recording device in the another direction are performed alternately. Moreover, the operation of the displacing device is controlled such that the ratio between the displacement amount of the relative displacement of the recording device in the one direction due to the recording of the record information and the displacement amount of the relative displacement of the recording device in the another direction is the predetermined ratio or less. Namely, there is no significant difference between the amounts of displacement directed in both the directions. Therefore, the relative displacement of the recording device due to the recording of the record information is not biased toward either the one direction or the another direction. Thus, it is possible to receive the same various benefits as those of the second recording medium described above.

Incidentally, the second recording apparatus may record the record information into the recording medium in which the track is formed, like the above-mentioned second recording medium, or may record the record information into the recording medium in which the track is not formed, like the above-mentioned fourth recording medium. In any cases, by virtue of the operation of the controlling device, it is possible to receive the above-mentioned various benefits.

Incidentally, in response to the various aspects of the second or fourth recording medium of the present invention described above, the second recording apparatus of the present invention can also adopt various aspects.

The above object of the present invention can be also achieved by a first recording method in a recording apparatus provided with: a recording device for recording record information into a recording medium; and a displacing device for relatively displacing the recording device with respect to the recording medium, in one direction and another direction different from the one direction, the recording method provided with: a first controlling process of controlling the displacing device such that a relative displacement direction of the recording device due to the recording of the record information is distributed substantially uniformly in both the one direction and the another direction; and a second controlling process of controlling the recording device to record the record information into the recording medium.

The above object of the present invention can be also achieved by a second recording method in a recording apparatus provided with: a recording device for recording record information into a recording medium; and a displacing device for relatively displacing the recording device with respect to the recording medium, in one direction and another direction different from the one direction, the recording method provided with: a first controlling device for controlling the displacing device such that relative displacement of the recording device in the one direction and relative displacement of the recording device in the another direction are performed alternately; and a second controlling process of controlling the displacing device such that a ratio between a displacement amount of the relative displacement of the recording device in the one direction and a displacement amount of the relative displacement of the recording device in the another direction, which is subsequent to the relative displacement of the recording device in the one direction, is a predetermined ratio or less.

According to the first or second recording method of the present invention, it is possible to receive the various benefits of the first or second recording apparatus of the present invention described above.

Incidentally, in response to the various aspects of the first or second recording apparatus of the present invention described above, the first or second recording method of the present invention can also adopt various aspects.

(Reproduction Apparatus and Method)

The above object of the present invention can be also achieved by a first reproducing apparatus provided with: a reproducing device for reproducing record information recorded in a recording medium; a displacing device for relatively displacing the reproducing device with respect to the recording medium, in one direction and another direction different from the one direction; and a controlling device for controlling the displacing device such that a relative displacement direction of the reproducing device due to the reproduction of the record information is distributed substantially uniformly in both the one direction and the another direction.

According to the first reproducing apparatus, by virtue of the operation of the reproducing device, the record information recorded in the recording medium is reproduced. Then, in reproducing the record information, by virtue of the operation of the displacing device, the reproducing device is displaced relatively with respect to the recording medium.

Particularly in the first reproducing apparatus, by virtue of the operation of the controlling device, the operation of the displacing device is controlled so as to realize such a reproduction operation that the relative displacement direction of the reproducing device due to the reproduction of the record information is distributed substantially uniformly in both the one direction and the another direction. Thus, the relative displacement direction of the reproducing device due to the reproduction of the record information is not biased toward either the one direction or the another direction. By this, it is possible to receive the same various benefits as those of the first recording medium described above.

Incidentally, the first reproducing apparatus may reproduce the record information recorded in the recording medium in which the track is formed, like the above-mentioned first recording medium, or may reproduce the record information recorded in the recording medium in which the track is not formed, like the above-mentioned third recording medium. In any cases, by virtue of the operation of the controlling device, it is possible to receive the above-mentioned various benefits.

Incidentally, in response to the various aspects of the first or third recording medium of the present invention described above, the first reproducing apparatus of the present invention can also adopt various aspects.

The above object of the present invention can be also achieved by a second reproducing apparatus provided with: a reproducing device for reproducing record information recorded in a recording medium; a displacing device for relatively displacing the reproducing device with respect to the recording medium, in one direction and another direction different from the one direction; and a controlling device for controlling the displacing device such that relative displacement of the reproducing device in the one direction and relative displacement of the reproducing device in the another direction are performed alternately and such that a ratio between a displacement amount of the relative displacement of the reproducing device in the one direction and a displacement amount of the relative displacement of the reproducing device in the another direction, which is performed subsequent to the relative displacement of the reproducing device in the one direction, is a predetermined ratio or less.

According to the second reproducing apparatus of the present invention, as in the first reproducing apparatus, by virtue of the operation of the reproducing device, the record information recorded in the recording medium is reproduced. Then, in reproducing the record information, by virtue of the operation of the displacing device, the reproducing device is displaced relatively with respect to the recording medium.

Particularly in the second reproducing apparatus, by virtue of the operation of the controlling device, the relative displacement of the reproducing device in the one direction and the relative displacement of the reproducing device in the another direction are performed alternately. Moreover, the operation of the displacing device is controlled such that the ratio between the displacement amount of the relative displacement of the reproducing device in the one direction due to the reproduction of the record information and the displacement amount of the relative displacement of the reproducing device in the another direction is the predetermined ratio or less. Namely, there is no significant difference between the amounts of displacement directed in both the directions. Therefore, the relative displacement of the reproducing device due to the reproduction of the record information is not biased toward either the one direction or the another direction. Thus, it is possible to receive the same various benefits as those of the second recording medium described above.

Incidentally, the second reproducing apparatus may reproduce the record information recorded in the recording medium in which the track is formed, like the above-mentioned second recording medium, or may reproduce the record information recorded in the recording medium in which the track is not formed, like the above-mentioned fourth recording medium. In any cases, by virtue of the operation of the controlling device, it is possible to receive the above-mentioned various benefits.

Incidentally, in response to the various aspects of the second or fourth recording medium of the present invention described above, the second reproducing apparatus of the present invention can also adopt various aspects.

The above object of the present invention can be also achieved by a first reproducing method in a reproducing apparatus provided with: a reproducing device for reproducing record information recorded in a recording medium; and a displacing device for relatively displacing the reproducing device with respect to the recording medium, in one direction and another direction different from the one direction, the reproducing method provided with: a first controlling process of controlling the displacing device such that a relative displacement direction of the reproducing device due to the reproduction of the record information is distributed substantially uniformly in both the one direction and the another direction; and a second controlling process of controlling the reproducing device to reproduce the record information recorded in the recording medium

The above object of the present invention can be also achieved by a second reproducing method in a reproducing apparatus provided with: a reproducing device for reproducing record information recorded in a recording medium; and a displacing device for relatively displacing the reproducing device with respect to the recording medium, in one direction and another direction different from the one direction, the reproducing method provided with: a first controlling process of controlling the displacing device such that relative displacement of the reproducing device in the one direction and relative displacement of the reproducing device in the another direction are performed alternately; and a second controlling process of controlling the displacing device such that a ratio between a displacement amount of the relative displacement of the reproducing device in the one direction and a displacement amount of the relative displacement of the reproducing device in the another direction, which is subsequent to the relative displacement of the reproducing device in the one direction, is a predetermined ratio or less.

According to the first or second reproducing method of the present invention, it is possible to receive the various benefits of the first or second reproducing apparatus of the present invention described above.

Incidentally, in response to the various aspects of the first or second reproducing apparatus of the present invention described above, the first or second reproducing method of the present invention can also adopt various aspects.

(Computer Program)

The above object of the present invention can be also achieved by a first computer program of instructions for recording control and for tangibly embodying a program of instructions executable by a computer provided in the above-mentioned first or second recording apparatus of the present invention (including its various aspects), the computer program making the computer function as the controlling device.

The above object of the present invention can be also achieved by a second computer program of instructions for reproduction control and for tangibly embodying a program of instructions executable by a computer provided in the above-mentioned first or second reproducing apparatus of the present invention (including its various aspects), the computer program making the computer function as the controlling device.

According to each of the computer programs of the present invention, the above-mentioned recording apparatus or reproducing apparatus of the present invention can be relatively easily realized as a computer reads and executes the computer program from a program storage device, such as a ROM, a CD-ROM, a DVD-ROM, and a hard disk, or as it executes the computer program after downloading the program through a communication device.

Incidentally, in response to the various aspects of the above-mentioned recording apparatus or reproducing apparatus of the present invention, each of the computer programs of the present invention can adopt various aspects.

The above object of the present invention can be also achieved by a first computer program product in a computer-readable medium for tangibly embodying a program of instructions executable by a computer provided in the above-mentioned first or second recording apparatus of the present invention (including its various aspects), to make the computer function as the controlling device.

The above object of the present invention can be also achieved by a first computer program product in a computer-readable medium for tangibly embodying a program of instructions executable by a computer provided in the above-mentioned first or second reproducing apparatus of the present invention (including its various aspects), to make the computer function as the controlling device.

According to each of the computer program products of the present invention, the above-mentioned recording apparatus or reproducing apparatus of the present invention can be embodied relatively readily, by loading the computer program product from a recording medium for storing the computer program product, such as a ROM (Read Only Memory), a CD-ROM (Compact Disc-Read Only Memory), a DVD-ROM (DVD Read Only Memory), a hard disk or the like, into the computer, or by downloading the computer program product, which may be a carrier wave, into the computer via a communication device. More specifically, the computer program product may include computer readable codes to cause the computer (or may comprise computer readable instructions for causing the computer) to function as the above-mentioned recording apparatus or reproducing apparatus of the present invention.

These effects and other advantages of the present invention will become more apparent from the following embodiments.

As explained above, according to the recording medium of the present invention, the track has the first partial track and the second partial track which are alternately formed, and the ratio of the track lengths of the first partial track and the second partial track, which are partially adjacent, is the predetermined ratio or less. Therefore, it is possible to stably record or reproduce data.

Moreover, according to the recording apparatus of the present invention, it is provided with the recording device, the displacing device, and the controlling device, and according to the recording method, it is provided with the first controlling process and the second controlling process. Therefore, it is possible to stably record data.

Moreover, according to the reproducing apparatus of the present invention, it is provided with the reproducing device, the displacing device, and the controlling device, and according to the reproducing method, it is provided with the first controlling process and the second controlling process. Therefore, it is possible to stably reproduce data.

### BRIEF DESCRIPTION OF DRAWINGS

FIG. 1 are a plan view and a cross sectional view conceptually showing one example of a dielectric recording medium, as an embodiment of the recording medium of the present invention.

FIG. 2 is a plan view conceptually showing the structure of a track formed on the recording surface of the dielectric recording medium in the embodiment.

FIG. 3 is a plan view conceptually showing the structure of a track formed on the recording surface of a dielectric recording medium in a comparison example.

FIG. 4 is a plan view conceptually showing the structure of the track formed on the recording surface of a dielectric recording medium in a modified example.

FIG. 5 is a plan view conceptually showing the structure of the track formed on the recording surface of a dielectric recording medium in a modified example.

FIG. 6 is a block diagram conceptually showing the basic structure of a recording/reproducing apparatus in the embodiment.

FIG. 7 is a cross sectional view conceptually showing a data recording operation by the recording/reproducing apparatus in the embodiment.

FIG. 8 is a schematic diagram conceptually showing the state of a data recording distribution when the data is recorded into a dielectric recording medium on which the track is not formed, by the recording/reproducing apparatus in the embodiment.

FIG. 9 is a cross sectional view conceptually showing a data reproduction operation by the recording/reproducing apparatus in the embodiment.

### DESCRIPTION OF REFERENCE CODES

60 recording/reproducing head
62 probe
80 X-Y stage
91 recording/reproduction processing circuit
94 displacement control circuit
95, 96 actuator
100 dielectric recording medium
116 electrode
117 dielectric material
120 track
121 partial track
300 recording/reproducing apparatus

### BEST MODE FOR CARRYING OUT THE INVENTION

Hereinafter, a best mode for carrying out the present invention will be explained for each embodiment in order with reference to the drawings.

Hereinafter, embodiments of the present invention will be explained with reference to the drawings.

(Recording Medium)

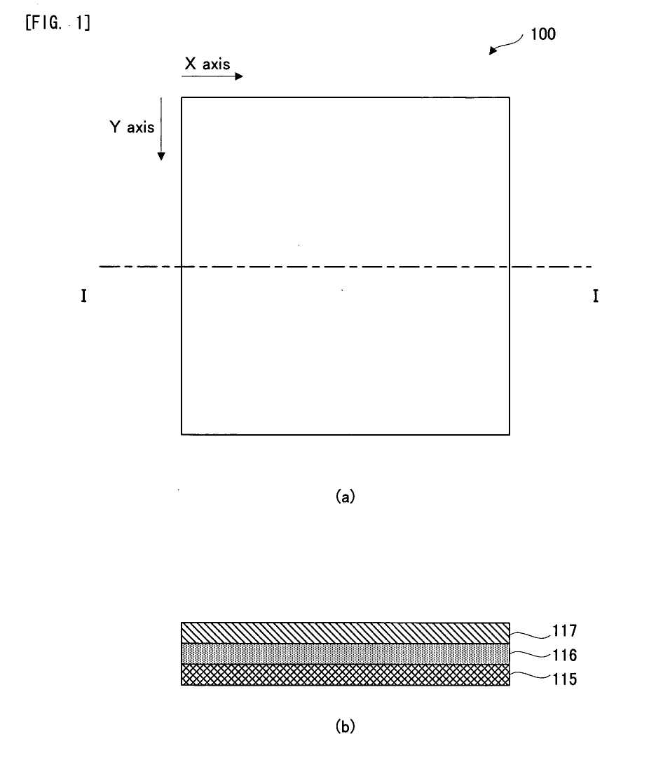

Firstly, with reference to FIG. 1, the outline structure in an embodiment of the recording medium of the present invention will be explained. FIG. 1 are a plan view and a cross sectional view conceptually showing one example of a dielectric recording medium 100, as the embodiment of the recording medium of the present invention.

As shown in FIG. 1(a), the dielectric recording medium 100 has a rectangular or quadrilateral recording surface. Along the recording surface, a probe 62 provided for a recoding/reproducing apparatus 300 described later is displaced along two driving axes of X axis and Y axis. Alternatively, the dielectric recording medium 100 itself is displaced along the two driving axes of X axis and Y axis. By this, desired data is recorded into a desired recording area. Incidentally, the X-axis direction corresponds to one specific example of the “one direction” of the present invention, while the Y-axis direction corresponds to one specific example of the “another direction” of the present invention.

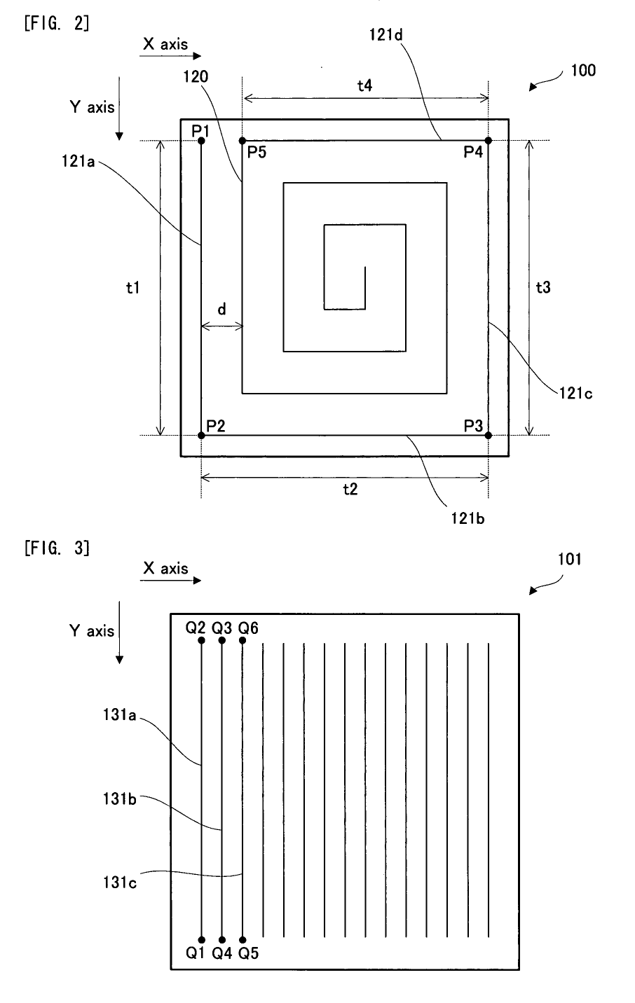

In particular, in the dielectric recording medium 100 in the embodiment, a track 120 is formed which will be a guide when data is recorded on the recording surface. Namely, the information recording/reproducing apparatus described later displaces the probe 62 or the dielectric recording medium 100 so as to displace the probe 62 along the track 120, to thereby record the data into the dielectric recording medium 100. In the same manner, upon data reproduction, the information recording/reproducing apparatus described later displaces the probe 62 or the dielectric recording medium 100 so as to displace the probe 62 along the track 120, to thereby reproduce the data recorded in the dielectric recording medium 100. The structure of the track 120 will be detailed later (refer to FIG. 2 to FIG. 4).

Moreover, FIG. 1(b) is an I-I cross sectional view of the dielectric recording medium 100 shown in FIG. 1(a). As shown in FIG. 1(b), the dielectric recording medium 100 is formed such that an electrode 116 is laminated on a substrate 115 and that a dielectric material 117 is laminated on the electrode 116.

The substrate 115 is Si (silicon), for example, which is a preferable material in its strength, chemical stability, workability, or the like. The electrode 116 is intended to generate an electric field between the electrode 116 and the probe 62. By applying such an electric field to the dielectric material 117 that is equal to or stronger than the coercive electric field of the dielectric material 117, the polarization direction is determined. By determining the polarization direction in accordance with the data, the recording is performed.

The dielectric material 117 is formed by a known technology, such as spattering LiTaO₃ or the like, which is a ferroelectric substance, onto the electrode 116. Then, the recording is performed with respect to the Z surface of LiTaO₃ in which the plus and minus surfaces of the polarization have a 180-degree domain relationship. It is obvious that other dielectric materials may be used. In the dielectric material 117, the small polarization is formed at high speed, by a voltage for data which is applied simultaneously with a direct current bias voltage.

Next, with reference to FIG. 2, the track 120 which is formed on the recording surface (specifically, on the dielectric material 117) of the dielectric recording medium 100 in the embodiment will be explained. FIG. 2 is a plan view conceptually showing the structure of the track 120 formed on the recording surface of the dielectric recording medium 100 in the embodiment. Incidentally, the following explanation will be made under the assumption that the probe 62 is displaced. However, it is obvious that the following explanation is applied even if the probe 62 is fixed and the dielectric recording medium 100 is displaced.

As shown in FIG. 2, each portion of the track 120 (hereinafter referred to as a “partial track”, as occasion demands) of the dielectric recording medium 100 in the embodiment is formed parallel to each side of the dielectric recording medium 100. The track 120 is formed to linearly extend from a point P1 to a point P2, then from the point P2 to a point P3, and further from the point P3 to a point P4. Namely, a partial track 121a is formed from the point P1 to the point P2, a partial track 121b is formed from the point P2 to the point P3, and a partial track 121c is formed from the point P3 to the point P4. At this time, it is constructed such that a distance t1 between the point P1 and the point P2 (i.e. the length of the partial track 121a), a distance t2 between the point P2 and the point P3 (i.e. the length of the partial track 121b), and a distance t3 between the point P3 and the point P4 (i.e. the length of the partial track 121c) are equal. Incidentally, the partial tracks 121b and 121d extending in the X-axis direction constitute one specific example of the “first partial track” of the present invention, and the partial tracks 121a and 121c extending in the Y-axis direction constitute one specific example of the “second partial track” of the present invention.

After that, the track 120 linearly extends from the point P4 to a point P5. Namely, a partial track 121d is formed from the point P4 to the point P5. At this time, the track 120 is formed on the recording surface of the dielectric recording medium 100 to have a spiral shape (or a whorl shape) made of a plurality of segments (partial tracks 121). Therefore, a distance t4 between the point P4 and the point P5 (i.e. the length of the partial track 121d) is shorter than the distance t3 between the point P3 and the point P4, for example, by a track pitch d. Even after the point P5, the track 120 is formed in the same aspect as that of the partial tracks 121a to 121d extending from the point P1 to the point P5.

In summary, the track 120 is formed such that the partial tracks 121 which are continuous (or partially adjacent) have the same or substantially the same length, or have a difference of track pitch d in length.

By designing the track 120 in this manner, the probe 62 can be displaced uniformly or substantially uniformly in each of the X-axis direction and the Y-axis direction when the probe 62 of a recording/reproducing apparatus 300 described later is displaced on the track 120. Specifically, for example, if the data is recorded or reproduced from the outer side of the dielectric recording medium 100, firstly, the probe 62 is displaced by the distance t1 in the Y-axis direction on the partial track 121a. Then, the probe 62 is displaced by the distance t2 (=t1) in the X-axis direction on the partial track 121b. Moreover, the probe 62 is further displaced by the distance t3 (=t1) in the Y-axis direction on the partial track 121c. At this time, in view of each unit of the partial tracks 121, the distance by which the probe 62 is displaced in the X-axis direction and the distance by which the probe 62 is displaced in the Y-axis direction are both equally t1. Moreover, the probe 62 is displaced by the distance t4 (=t1−d) in the X-axis direction on the partial track 121d. At this time, the distance by which the probe 62 is displaced is slightly shorter than the other previous displacement distances in units of the partial track 121. However, considering that the track pitch d is smaller than the length of each of the partial tracks 121, the displacement distance can be regarded as substantially the same. Namely, according to the dielectric recording medium 100 in the embodiment, the displacement direction of the probe 62 is not biased toward either the X-axis direction or the Y-axis direction, but is distributed uniformly or substantially uniformly in both the X-axis direction and the Y-axis direction.

Now, with reference to FIG. 3, a comparison example of the dielectric recording medium 100 in the embodiment will be explained. FIG. 3 is a plan view conceptually showing the structure of a track 130 formed on the recording surface of a dielectric recording medium 101 in the comparison example.

As shown in FIG. 3, on the recording surface of the dielectric recording medium 101 in the comparison example, the track 130 is formed so as to form a plurality of partial tracks 131 parallel to a particular side of the dielectric recording medium 101. Namely, the track 130 is formed such that all the partial tracks 131 have a parallel positional relationship. If data is recorded or reproduced with respect to the dielectric recording medium 101 on which such a track 130 is formed, the probe 62 is firstly displaced in the Y-axis direction (i.e. from a point Q1 to a point Q2) on a partial track 131a. Then, since a next partial track 131b is a next target for data recording or reproduction, the probe 62 is displaced by the track pitch d in the X-axis direction (i.e. from the point Q2 to a point Q3). Then, the probe 62 is displaced in the Y-axis direction (i.e. from the point Q3 to a point Q4) on the partial track 131b. By repeating the same operation subsequently, data is recorded or reproduced with respect to the dielectric recording medium 101 in the comparison example.

As described above, in the dielectric recording medium 101 in the comparison example, the distance that the probe 62 is displaced is extremely large in the Y-axis direction, while it is extremely small in the X-axis direction. In other words, the displacement direction of the probe 62 is significantly biased toward the Y-axis direction.

However, according to the dielectric recording medium 100 in the embodiment, the displacement direction of the probe 62 is distributed uniformly or substantially uniformly in both the X-axis direction and the Y-axis direction. Therefore, it is possible to effectively prevent such a disadvantage that the tip of the probe 62 is disproportionately abraded because the displacement direction of the probe 62 is biased toward the Y-axis direction, for example. Namely, since the tip of the probe 62 is abraded uniformly in both the X-axis direction and the Y-axis direction, it is possible to relatively extend the operation lifetime of the probe 62. As a result, it is possible to stably record data into the dielectric recording medium 100, and stably reproduce the data recorded in the dielectric recording medium 100.

In the same manner, it is also possible to prevent such a disadvantage that the driving mechanism for displacing the probe 62 in the Y-axis direction is overworked beyond necessity because the displacement direction of the probe 62 is biased toward the Y-axis direction, for example. Namely, if data is recorded or reproduced with respect to the dielectric recording medium 100 in the embodiment, both the driving mechanism for displacing the probe in the Y-axis direction and the driving mechanism for displacing the probe in the X-axis direction operate at a uniform or substantially uniform frequency. Therefore, it is possible to prevent such a disadvantage that one of the driving mechanisms goes wrong though the other does not. As a result, it is possible to extend the operation lifetime of the entire recording/reproducing apparatus 300. Moreover, since both the driving mechanism for displacing the probe in the Y-axis direction and the driving mechanism for displacing the probe in the X-axis direction operate at a uniform or substantially uniform frequency, each of the driving mechanisms has substantially the same aspect of heat generation. Thus, it is possible to effectively prevent such disadvantages that the heat generation is focused on one of the driving mechanisms, resulting in bad heat radiation and an unstable operation of the recording/reproducing apparatus 300.

Moreover, if the data recording or reproduction target is changed from one partial track 121 to another partial track 121, it is possible to effectively prevent such a disadvantage that the direction of acceleration provided to the probe 62 is suddenly changed. Namely, in the comparison example, if the data recording or reproduction target is changed from one partial track 131a to another partial track 131b, the direction of acceleration provided to the probe 62 is quickly changed in a short time, like from the Y-axis direction to the X-axis direction, and further immediately to the Y-axis direction. According to the embodiment, however, if the data recording or reproduction target is changed from one partial track 121a to another partial track 121b, the direction of acceleration provided to the probe 62 is changed only from the Y-axis direction to the X-axis direction. Namely, the direction of acceleration is not quickly changed in a short time, so that it is possible to reduce stress put on the probe 62. Therefore, it is possible to relatively prevent the damage of the probe 62, to thereby extend the lifetime of the probe 62. In addition, since the direction of acceleration is not quickly changed in a short time, unnecessary vibration or oscillation does not occur or hardly occurs on the probe 62. Therefore, it is possible to effectively prevent such a disadvantage that resonance occurs as a whole, which makes the operations of the recording/reproducing apparatus remarkably unstable, because this vibration matches the resonance frequency of the driving mechanisms and other components. As a result, it is possible to stably record data into the dielectric recording medium 100, and stably reproduce the data recorded in the dielectric recording medium 100.

However, even if the partial tracks 121 which are continuous (or partially adjacent) do not have the same or substantially the same length, or have a difference of track pitch d or more in length, as long as the displacement direction of the probe 62 is not biased toward either the X-axis direction or the Y-axis direction, then the length, shape, or the like thereof can be arbitrarily selected. Namely, even if the partial tracks 121 which are continuous (or partially adjacent) have significantly different lengths, as long as the partial tracks are distributed on the recording surface such that the displacement direction of the probe 62 is not biased toward either the X-axis direction or the Y-axis direction, it is included in the scope of the present invention. Moreover, since it is only necessary to form such a track 120 that the displacement direction of the probe 62 is not biased toward either the X-axis direction or the Y-axis direction, such a track 120 that the displacement direction of the probe 62 is not distributed uniformly or substantially uniformly in both the X-axis direction and the Y-axis direction, unlike the above, may be formed. The point is that as long as the displacement direction of the probe 62 is not biased toward either the X-axis direction or the Y-axis direction, the length, shape, or the like of the track 120 is not limited.

Moreover, from the viewpoint that the displacement direction of the probe 62 is distributed uniformly or substantially uniformly in both the X-axis direction and the Y-axis direction, the track 120 is preferably formed such that a ratio of the lengths of the partial tracks 121 which are continuous (or partially adjacent) is about 20% or less. More specifically, with regard to the partial track 121c and the partial track 121d, which are partially adjacent, their respective lengths t3 and t4 (incidentally, t3≧t4) preferably satisfy a relationship of t4/t3≧1/1.12 (or t3/t4≦1/1.2).

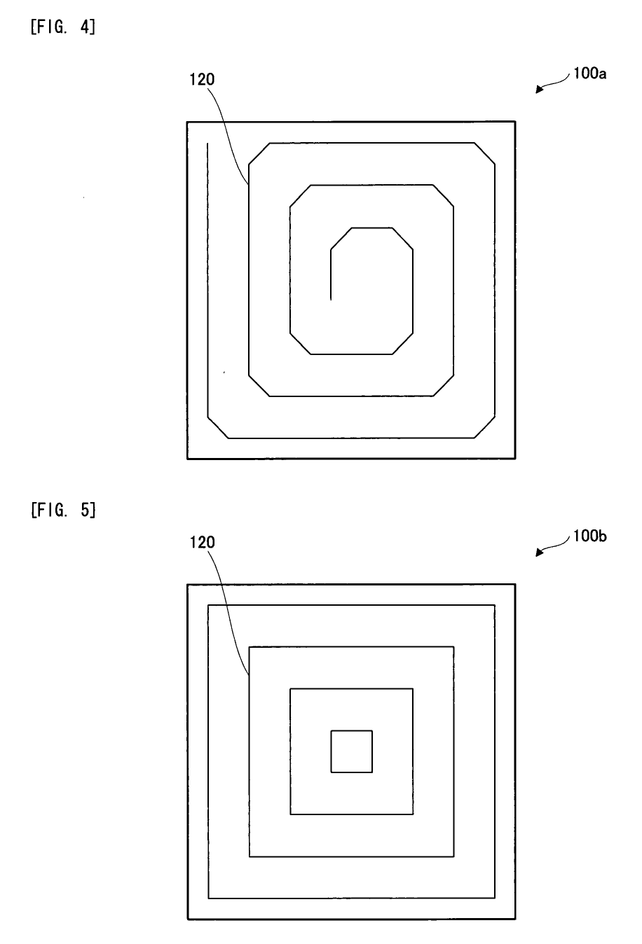

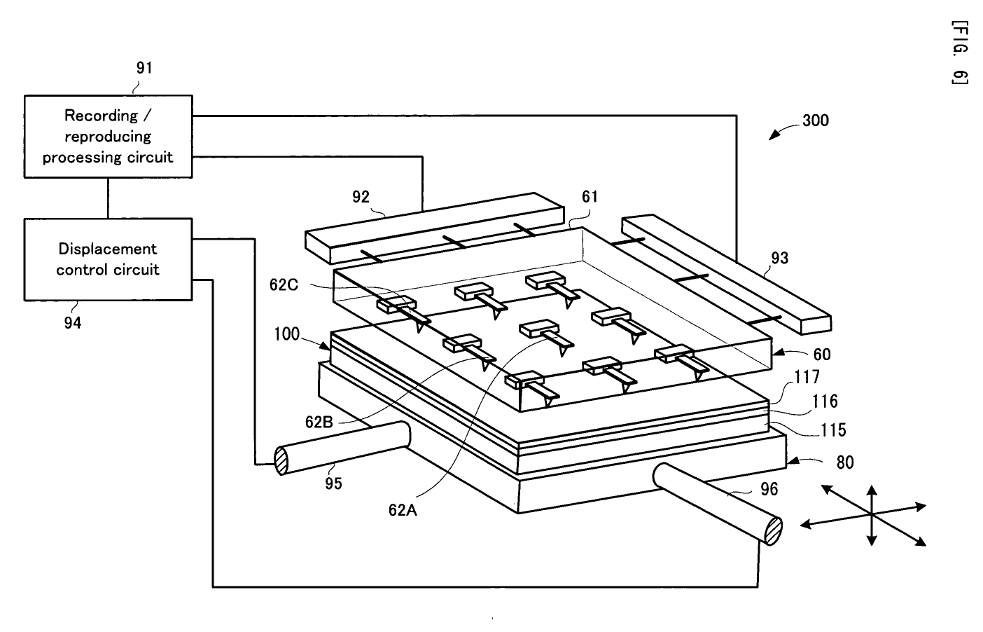

Next, with reference to FIG. 4 and FIG. 5, modified examples of the dielectric recording medium 100 in the embodiment will be explained. Each of FIG. 4 and FIG. 5 is a plan view conceptually showing the structure of the track formed on the recording surface of a dielectric recording medium 100a (or 100b) in a modified example.

As shown in FIG. 4, in the dielectric recording medium 100a in the modified example, the track 120 is formed so as to change the displacement direction more smoothly in points where the displacement direction of the probe 62 is changed (e.g. points corresponding to the points P1, P2, P3, P4, and P5 in FIG. 2). Specifically, the track 120 is formed so as to relieve edges corresponding to the points where the partially adjacent partial tracks 121 are supposedly in contact. Namely, the shape of the track 120 is quadrilateral in FIG. 2; however, the track 120 may be formed to be an octagon by reliving the edges. By this, it is possible to change the direction of acceleration provided to the probe 62, more smoothly, to thereby relatively prevent the damage of the probe 62. Moreover, unnecessary vibration or oscillation does not occur or hardly occurs on the probe 62. Therefore, it is possible to stably record data into the dielectric recording medium 100, and stably reproduce the data recorded in the dielectric recording medium 100. Incidentally, the portions of the partial tracks 121 corresponding to the edge-relieved portions constitute one specific example of the “third partial track” of the present invention.

Incidentally, the shape of the track 120 formed after relieving the edges is not limited to the octagon shown in FIG. 4, but it may be, for example, a ¼ circular shape or an arbitrary curved shape, in the portions where the partially adjacent partial tracks 121 are supposedly in contact. As described above, as long as the displacement direction of the probe 62 is not biased toward either the X-axis direction or the Y-axis direction, then an arbitrary shape can be adopted.

Moreover, the track 120 is not necessarily one line, as shown in FIG. 2 and FIG. 4. As shown in FIG. 5, in the dielectric recording medium 100b in the modified example, the track 120 is formed of a plurality of closed curves. Even in this case, it is possible to receive the same benefits as those explained by using FIG. 2 and the like.

Incidentally, the track 120 may be formed as a dent or concave portion on the recording surface, or may be a convex portion on the recording surface. Alternatively, the cross sectional shape and other physical properties of the track 120 are not particularly limited as long as the physical properties of the track 120 are different from those of another portion of the recording surface. For example, the track 120 may be formed by making the crystal structure of a material, which forms the recording surface, thereof differ from that of another portion. For example, if the recording surface is the ferroelectric material 117, the track 120 may be formed by making the polarization direction of the ferroelectric material 117 thereof differ from that of another portion. Alternatively, if the recording surface is formed of a phase change material, instead of the ferroelectric material 117, the track 120 may be formed by setting only the portion corresponding to the track 120 into an amorphous phase.

Moreover, even if the track 120 is not actually formed, as long as data is recorded in such an aspect that the data is along the track 120, as shown in FIG. 2 to FIG. 4, then the dielectric recording medium is included in the scope of the present invention. Namely, as long as the data is recorded such that the displacement direction of the probe 62 is not biased toward either the X-axis direction of the Y-axis direction in reproducing the data, the dielectric recording medium is included in the scope of the present invention.

Moreover, in the above-mentioned embodiment, an explanation was given to the case where the probe 62 is displaced in directions of two axes crossing at right angles. Of course, even if the probe 62 is displaced along arbitrary axes which do not cross at right angles, as long as the track 120 is formed such that the displacement direction of the probe 62 is not biased toward one of the axis directions, the dielectric recording medium is included in the scope of the present invention. Moreover, the number of axes is not limited to two, and even if the probe 62 is displaced along three or more axes, as long as the track 120 is formed such that the displacement direction of the probe 62 is not biased toward one of the axis directions, the dielectric recording medium is included in the scope of the present invention.

(Recording/Reproducing Apparatus)

Next, with reference to FIG. 6 to FIG. 9, the embodiment of the recording apparatus and the reproducing apparatus of the present invention will be explained. Incidentally, the recording/reproducing apparatus 300 in the embodiment can record data into the dielectric recording medium 100 in the above-mentioned embodiment, and reproduce the data recorded in the dielectric recording medium 100 in the above-mentioned embodiment. Namely, the components for recording the data into the dielectric recording medium 100 constitutes one specific example of the recording apparatus of the present invention. On the other hand, the components for reproducing the data recorded in the dielectric recording medium 100 constitutes one specific example of the reproducing apparatus of the present invention.

(1) Basic Structure

Firstly, with reference to FIG. 6, the basic structure of the recording/reproducing apparatus 300 will be explained, as the embodiment of the recording apparatus, the reproducing apparatus, and the recording/reproducing apparatus of the present invention. FIG. 6 is a block diagram conceptually showing the basic structure of the recording/reproducing apparatus 300 in this embodiment.

As shown in FIG. 6, the recording/reproducing apparatus 300 in the embodiment is provided with: a recording/reproducing head 60; the dielectric recording medium 100; an X-Y stage 80; a recording/reproduction processing circuit 91; and a displacement control circuit 94.

The recording/reproducing head 60 constitutes one specific example of the “recording device”, the “reproducing device”, and the “recording/reproducing device” of the present invention, and is provided with: a support device 61; and probes 62A, 62B and so on. The support device 61 of the recording/reproducing head 60 supports the probes 62A, 62B and so on. Specifically, the probes 62A, 62B and so on are supported on the bottom surface of the support device 61. The support device 61 is made of a substrate, such as, e.g., silicon compounds, glass, metal or the like. The support device 61 is disposed above the recording surface of the dielectric recording medium 100. Incidentally, for convenience of explanation, the support device 61 is transparently shown in FIG. 6; however, usually, the support device 61 is not transparent, though it may be transparent depending on the selection of the material in some cases.

The probes 62A, 62B and so on include a member having a conductive property, such as high-doped silicon, high-doped diamond or the like. Each of the probes 62A, 62B and so on is provided with a beam and a needle. The beam has elasticity and can be bended. The beam is supported by the support device 61 on the rear anchor side of the beam, and is provided with the needle on the tip of the beam. The needle has a tip diameter of several nanometers to several tens nanometers. The total number of the probes 62A, 62B and so on is 9, and these are arranged in a matrix of 3×3 on the support device 61. Incidentally, for convenience of explanation, the total number of the probes 62A, 62B and so on is set 9; however, actually, it is several tens to several hundreds.

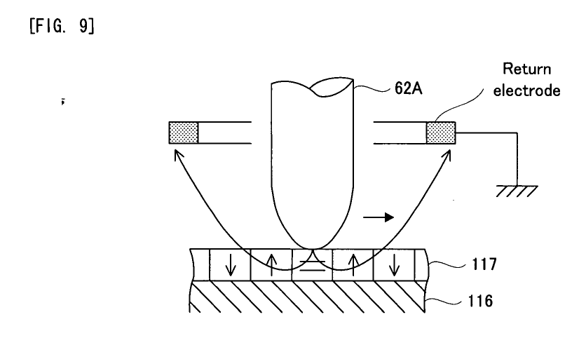

Moreover, the recording/reproducing apparatus 300 is provided with a not-illustrate return electrode in the surrounding portion of the probes 62A, 62B, and so on. The return electrode is used in reproducing the data recorded in the dielectric recording medium. This operation will be detailed later (refer to FIG. 9).

The X-Y stage 80 displaces the dielectric recording medium 100 mounted thereon, in the X-axis direction and the Y-axis direction.

On the other hand, the recording/reproduction processing circuit 91 is provided with: an arithmetic processing circuit; a memory circuit; and the like. The recording/reproduction processing circuit 91 is electrically connected to the probes 62A, 62B, and so on, via multiplexers 92 and 93. The recording/reproduction processing circuit 91 mainly supplies electrical signals corresponding to data to be recorded into the dielectric recoding medium to the probes 62A, 62B, and so on, upon the data recording. Moreover, the recording/reproduction processing circuit 91 receives the data (detection signals) read by the probes 62A, 62B, and so on, upon the data reproduction, and performs a data reproduction operation.

The displacement control circuit 94 constitutes one specific example of the “controlling device” of the present invention, and is provided with: an arithmetic processing circuit; a memory circuit; and the like. The displacement control circuit 94 is electrically connected to the recording/reproduction processing circuit 91, so that the data can be exchanged between the both circuits. Moreover, the displacement control circuit 94 is connected to the X-Y stage 80, via actuators 95 and 96 which constitute one specific example of the “displacing device” of the present invention. The displacement control circuit 94 controls the X-Y stage 80, displaces the dielectric recording medium 100 in the X-axis direction and the Y-axis direction, and displaces the probes 62A, 62B, and so on, to desired positions.

(2) Recording Operation

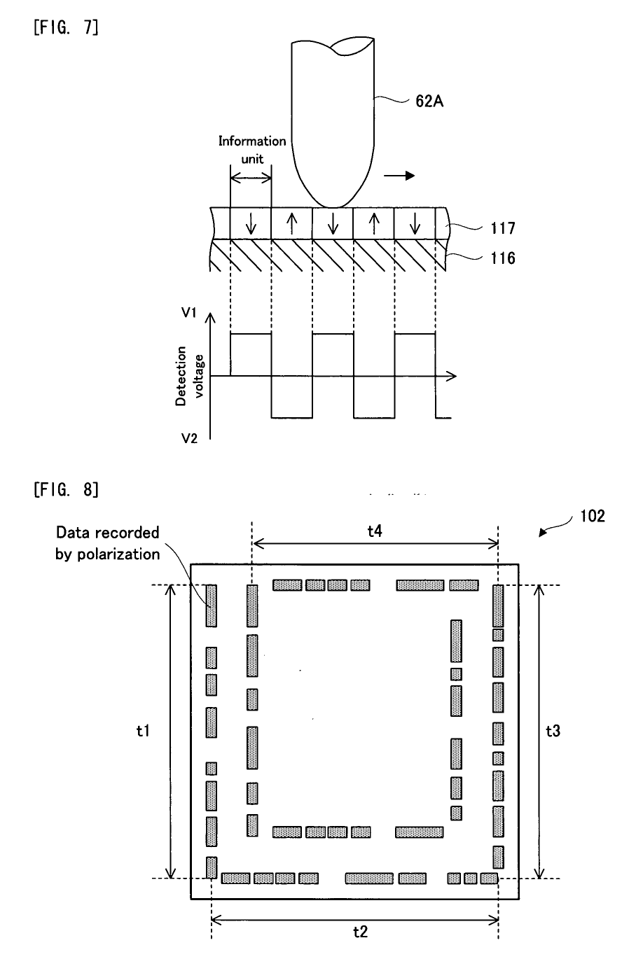

Next, with reference to FIG. 7, the recording operation of the dielectric recording/reproducing in the embodiment will be explained. FIG. 7 is a cross sectional view conceptually showing the information recording operation. Incidentally, here, an explanation will be given to one probe 62A out of the plurality of probes 62A, 62B, and so on provided for the recording/reproducing head 60. Of course, it is obvious that the other probes 62B and so on also perform the same operation.

As shown in FIG. 7, the dielectric material is polarized in a direction corresponding to the direction of an applied electric field by applying the electric field that is equal to or greater than the coercive electric field of the dielectric material 117, between the probe 62A (more specifically, the needle provided for the probe 62A) and the electrode 116. By controlling an applied voltage and changing the polarization direction, it is possible to record predetermined information. This uses such a characteristic that if an electric field which exceeds the coercive electric field of a dielectric substance (particularly, a ferroelectric substance) is applied to the dielectric substance, the polarization direction is reversed, and that the polarization direction is maintained.

For example, if an electric field directed from the probe 62A to the electrode 116 is applied, a micro domain has downward polarization P. If an electric field directed from the electrode 116 to the probe 62A is applied, a micro domain has upward polarization P. This corresponds to the state that the information is recorded. If the probe 62A is operated in an arrow-pointing direction (e.g. the X-axis direction or the Y-axis direction), a detection voltage is outputted as a square wave which swings up and down, in accordance with the polarization P. Incidentally, this level changes depending on the polarization extent of the polarization P, and can be recorded as an analog signal.

In this recording operation, under the control of the displacement control circuit 94, the probe 62A is displaced relatively with respect to the dielectric recording medium 100 along the track 120. Namely, the track 120 is detected, and the actuators 95 and 96 are operated so as to relatively displace the probe 62A along the detected track, to thereby displace the X-Y stage 80. By this, it is possible to receive the above-mentioned various benefits.

Incidentally, data may be recorded without detecting the track 120. This recording operation will be explained with reference to FIG. 8. FIG. 8 is a schematic diagram conceptually showing the state of a data recording distribution when the data is recorded into a dielectric recording medium 102 on which the track 120 is not formed, by the recording/reproducing apparatus 300 in the embodiment.

As shown in FIG. 8, the actuators 95 and 96 may be operated, under the control of the displacement control circuit 94, such that data is recorded in the same pattern as the pattern by which the track 120 is formed, into the dielectric recording medium 102 on which the track 120 is not formed. Namely, with or without the track 120, data may be recorded, with the actuators 95 and 96 operated such that the displacement direction of the probe 62 is not biased toward either the X-axis direction or the Y-axis direction. Even in such construction, it is possible to receive the above-mentioned various benefits, and the recording/reproducing apparatus which performs such an operation is also included in the scope of the present invention.

(Reproduction Operation)

Next, with reference to FIG. 9, the reproduction operation of a dielectric recording/reproducing apparatus 1 in the embodiment will be explained. FIG. 9 is a cross sectional view conceptually showing the data reproduction operation.

The nonlinear dielectric constant of the dielectric substance changes in association with the polarization direction of the dielectric substance. Then, the nonlinear dielectric constant of the dielectric substance can be detected as a difference in the capacitance of the dielectric substance or a difference in change of the capacitance, when an electric field is applied to the dielectric substance. Therefore, by applying an electric field to the dielectric material and detecting a difference in the capacitance Cs in a particular micro domain of the dielectric material at that time or a difference in change of the capacitance Cs, it is possible to read and reproduce the data recorded as the polarization direction of the dielectric material.

Specifically, firstly, as shown in FIG. 9, an alternating electric field from a not-illustrated alternating current (AC) signal generator is supplied between the electrode 116 and the probe 62A (i.e. the needle provided for the probe 62A). This alternating electric field has an electric field strength to the extend that it is not beyond the coercive electric field of the dielectric material 117, and has a frequency of about 5 kHz. The alternating electric field is generated mainly to distinguish the difference in change of the capacitance corresponding to the polarization direction of the dielectric material 117. Incidentally, instead of the alternating electric field, a direct current bias voltage may be applied to form an electric field in the dielectric material 117. When the alternating electric field is applied, an electric field is generated in the dielectric material 117 of the dielectric recording medium 100.

Then, the probe 62A is put closer to the recording surface until the distance between the tip of the probe 62A and the recording surface becomes extremely small on the order of nanometers. Under this condition, a not-illustrated oscillator is driven. Incidentally, in order to detect the capacitance Cs of the dielectric material 117 under the probe 62A highly accurately, it is preferable to contact the probe 62A with the surface of the dielectric material 117, i.e. the recording surface. However, even if the tip of the probe 62A is not in contact with the recording surface, for example, even if the tip of the probe 62A is put closer to the recording surface to the extent that can be substantially regarded as the contact, the reproduction operation (moreover, the above-mentioned recording operation) can be performed.

Then, the oscillator oscillates at the resonance frequency of a resonance circuit, which includes the inductor L and the capacitance Cs associated with the dielectric material 117 under the probe 62A, as the constituent elements. The center frequency of the resonance frequency is set to approximately 1 GHz, as described above.

Here, the return electrode and the probe 62A constitute one portion of the oscillation circuit including the oscillator. The high-frequency signal of approximately 1 GHz, which is applied to the dielectric material 17 from the probe 62A, passes through the dielectric material 117 and returns to the return electrode, as shown by solid lines in FIG. 9. By disposing the return electrode in the vicinity of the probe 62A and shortening a feedback route to the oscillation circuit including the oscillator, it is possible to reduce noise (e.g. a floating capacitance component) entering in the oscillation circuit.

In addition, the change of the capacitance Cs corresponding to the nonlinear dielectric constant of the dielectric material 117 is extremely small, and in order to detect this change, it is necessary to adopt a detection method having high detection accuracy. In a detection method using FM modulation, generally, the high detection accuracy can be obtained, but it is necessary to further improve the detection accuracy, in order to make it possible to detect the small capacitance change corresponding to the nonlinear dielectric constant of the dielectric material 117. Thus, in the recording/reproducing apparatus 300 in the embodiment (i.e. recording/reproducing apparatus which uses the SNDM principle), the return electrode is located in the vicinity of the probe 62A to shorten the feedback route to the oscillation circuit as much as possible. By this, it is possible to obtain extremely high detection accuracy, and thus it is possible to detect the small capacitance change corresponding to the nonlinear dielectric constant of the dielectric substance.

After the oscillator is driven, the probe 62A is displaced in parallel with the recording surface on the dielectric recording medium 100. Due to the displacement, the domain of the dielectric material 117 under the probe 62A is changed, and whenever the polarization direction thereof changes, the capacitance Cs changes. If the capacitance Cs changes, the resonance frequency, i.e. the oscillation frequency of the oscillator, changes. As a result, the oscillator outputs a signal which is FM-modulated on the basis of the change of the capacitance Cs.

This FM signal is frequency-voltage converted by a demodulator. As a result, the change of the capacitance Cs is converted to the extent of a voltage. The change of the capacitance Cs corresponds to the nonlinear dielectric constant component of the dielectric material 117. The nonlinear dielectric constant component corresponds to the polarization direction of the dielectric material 117. The polarization direction corresponds to the data recorded in the dielectric material 117. Therefore, a signal obtained from the demodulator is a signal in which a voltage changes correspondingly to the data recorded in the dielectric recording medium 100. Moreover, for example, coherent detection or synchronous detection is performed on the signal obtained from the demodulator, to thereby extract the data recorded in the dielectric recording medium 100.

In the coherent detection, an AC signal generated by the AC signal generator is used as a reference signal. By this, for example, even if the signal obtained from the demodulator includes a lot of noises, or data to be extracted is small, the data can be extracted highly accurately, by synchronizing it with the reference signal, as described later.

In the reproduction operation, under the control of the displacement control circuit 94, the probe 62A is displaced relatively with respect to the dielectric recording medium 100 along the track 120 (or along the recorded data). Namely, the track 120 is detected, and the actuators 95 and 96 are operated so as to relatively displace the probe 62A along the detected track 120, to thereby displace the X-Y stage 80. By this, it is possible to receive the above-mentioned various benefits.

At this time, with or without the track 120, the probe 62A may be displaced relatively with respect to the dielectric recording medium 100, in accordance with the same pattern as the above-mentioned pattern by which the track 120 is formed, by operating the actuators 95 and 96 under the control of the displacement control circuit 94.

Moreover, in the recording/reproducing apparatus 300 in the embodiment, an explanation was given to the case where the probes 62A, 62B, and so on (or the recording/reproducing head 60) are displaced relatively with respect to the dielectric recording medium 100 in the directions of two axes crossing at right angles. Of course, even if the probes 62A, 62B, and so on are displaced relatively with respect to the dielectric recording medium 100 along arbitrary axes which do not cross at right angles, as long as the displacement direction of the probes 62A, 62B, and so on is not biased toward one of the axis directions, the dielectric recording/reproducing apparatus is included in the scope of the present invention. Moreover, the number of axes is not limited to two, and even if the probes 62A, 62B, and so on are displaced relatively with respect to the dielectric recording medium 100 along three or more axes, as long as the displacement direction of the probes 62A, 62B, and so on is not biased toward one of the axis directions, the dielectric recording/reproducing apparatus is included in the scope of the present invention. Moreover, as long as the relative displacement direction of the probes 62A, 62B, and so on is not biased toward either the X-axis direction or the Y-axis direction, the displacement aspect can be arbitrarily selected.

Moreover, from the viewpoint that the relative displacement direction of the probes 62A, 62B, and so on is distributed uniformly or substantially uniformly in both the X-axis direction and the Y-axis direction, the displacement control circuit 94 preferably controls the actuators 95 and 96 such that a ratio between the distance by which the probes 62A, 62B and so on are relatively displaced in the X-axis direction (or the Y-axis direction) and the distance by which the probes 62A, 62B and so on are subsequently relatively displaced in the Y-axis direction (or the X-axis direction) is, for example, about 20% or less.

Moreover, in the above-mentioned embodiment, the dielectric material 117 is used for the recording layer; however, from the viewpoint of the presence or absence of the nonlinear dielectric constant and spontaneous polarization, the dielectric material 117 is preferably a ferroelectric substance.

Incidentally, as the specific example of the recording medium, the dielectric recording medium 100 is used. Moreover, as the specific example of the recording/reproducing apparatus, the recording/reproducing apparatus 300 for recording the data into the dielectric recording medium 100 or reproducing the data recorded in the dielectric recording medium 100 is used for the explanation. Of course, it is obvious that the above-mentioned various structures and configurations can be applied to the other various recording media and recording/reproducing apparatuses currently commercially available or under development.

Moreover, in the present invention, various changes may be made, if desired, without departing from the essence or spirit of the invention which can be read from the claims and the entire specification. A recording medium, a recording apparatus and method, a reproducing apparatus and method, a recording/reproducing apparatus and method, and a computer program, which involve such changes, are also intended to be within the technical scope of the present invention.

### INDUSTRIAL APPLICABILITY

The recording medium, the recording apparatus and method, the reproducing apparatus and method, the recording/reproducing apparatus and method, and the computer program of the preset invention can be applied to a recording medium, such as, e.g., a dielectric recording medium, a recording apparatus for recording record information into such a recording medium, and a reproducing apparatus for reproducing the record information from such a recording medium. Moreover, they can be applied to a recording/reproducing apparatus or the like which is mounted on various computer equipment for consumer use or for commercial use, or which can be connected to various computer equipment.

1. A recording medium on which record information is recorded, wherein said recording medium is displaced relatively with respect to a recording/reproducing device for performing at least one of recording and reproduction of the record information, along each of one direction and another direction different from the one direction, and
on a recording surface of said recording medium, a track which is a guide in recording the record information is formed such that a relative displacement direction of the recording/reproducing device due to the at least one of recording and reproduction of the record information is distributed substantially uniformly in both the one direction and the another direction.

2. The recording medium according to claim 1, wherein the track is formed such that a first partial track which extends in the one direction and a second partial track which extends in the another direction are alternately formed and such that a ratio of track lengths of the first partial track and the second partial track which are partially adjacent is a predetermined value or less.

3. The recording medium according to claim 1, wherein the track is formed to have a third partial track which extends in a direction different from each of the one direction and the another direction between a first partial track which extends in the one direction and a second partial track which extends in the another direction and is partially adjacent to the first partial track.

4. The recording medium according to claim 1, wherein track lengths of a first partial track which extends in the one direction and a second partial track which extends in the another direction and is partially adjacent to the first partial track are substantially the same.

5. A recording medium on which record information is recorded, wherein
on a recording surface of said recording medium, a track which is a guide in recording the record information is formed, and
the track is formed such that a first partial track which extends in one direction and a second partial track which extends in another direction different from the one direction are alternately formed and such that a ratio of track lengths of the first partial track and the second partial track which are partially adjacent is a predetermined value or less.

6. The recording medium according to claim 5, wherein said recording medium is displaced relatively with respect to a recording/reproducing device for performing at least one of recording and reproduction of the record information, along each of the one direction and the another direction.

7. The recording medium according to claim 6, wherein the track is formed such that a relative displacement direction of the recording/reproducing device due to the at least one of recording and reproduction of the record information is distributed substantially uniformly in both the one direction and the another direction.

8. The recording medium according to claim 5, wherein the track is formed to have a third partial track which extends in a direction different from the one direction and the another direction between the first partial track and the second partial track.

9. The recording medium according to claim 5, wherein track lengths of the first partial track and the second partial track which are partially adjacent are substantially the same.

10. The recording medium according to claim 1, wherein the one direction and the another direction cross at right angles.

11. The recording medium according to claim 5, wherein the one direction and the another direction cross at right angles.

12. The recording medium according to claim 1, wherein one portion of the track and another portion other than the one portion do not cross each other.

13. The recording medium according to claim 5, wherein one portion of the track and another portion other than the one portion do not cross each other.

14. The recording medium according to claim 1, wherein the track is spirally formed on the recording surface.

15. The recording medium according to claim 5, wherein the track is spirally formed on the recording surface.

16. The recording medium according to claim 1, wherein a plurality of tracks are independently formed.

17. The recording medium according to claim 5, wherein a plurality of tracks are independently formed.

18. The recording medium according to claim 16, wherein at least one of the plurality of tracks independently formed is a closed curve.

19. The recording medium according to claim 17, wherein at least one of the plurality of tracks independently formed is a closed curve.

20. A recording medium on which record information is recorded, wherein
said recording medium is displaced relatively with respect to a recording/reproducing device for performing at least one of recording and reproduction of the record information, along each of one direction and another direction different from the one direction, and
on a recording surface of said recording medium, the record information is recorded such that a relative displacement direction of the recording/reproducing device due to the at least one of recording and reproduction of the record information is distributed substantially uniformly in both the one direction and the another direction.

21. A recording medium on which record information is recorded, wherein
said recording medium alternately has a first area in which the record information is recorded in one direction and a second area in which the record information is recorded in another direction different from the one direction, and
a ratio of lengths of the first area and the second area which are partially adjacent is a predetermined value or less.

22. A recording apparatus comprising:
a recording device for recording record information into a recording medium;
a displacing device for relatively displacing said recording device with respect to the recording medium, in one direction and another direction different from the one direction; and
a controlling device for controlling said displacing device such that a relative displacement direction of said recording device due to the recording of the record information is distributed substantially uniformly in both the one direction and the another direction.

23. A recording apparatus comprising:
a recording device for recording record information into a recording medium;
a displacing device for relatively displacing said recording device with respect to the recording medium, in one direction and another direction different from the one direction; and
a controlling device for controlling said displacing device such that relative displacement of said recording device in the one direction and relative displacement of said recording device in the another direction are performed alternately and such that a ratio between a displacement amount of the relative displacement of said recording device in the one direction and a displacement amount of the relative displacement of said recording device in the another direction, which is performed subsequent to the relative displacement of said recording device in the one direction, is a predetermined ratio or less.

24. A recording method in a recording apparatus comprising: a recording device for recording record information into a recording medium; and a displacing device for relatively displacing said recording device with respect to the recording medium, in one direction and another direction different from the one direction, said recording method comprising:
a first controlling process of controlling said displacing device such that a relative displacement direction of said recording device due to the recording of the record information is distributed substantially uniformly in both the one direction and the another direction; and
a second controlling process of controlling said recording device to record the record information into the recording medium.

25. A recording method in a recording apparatus comprising: a recording device for recording record information into a recording medium; and a displacing device for relatively displacing said recording device with respect to the recording medium, in one direction and another direction different from the one direction, said recording method comprising:
a first controlling device for controlling said displacing device such that relative displacement of said recording device in the one direction and relative displacement of said recording device in the another direction are performed alternately; and
a second controlling process of controlling said displacing device such that a ratio between a displacement amount of the relative displacement of said recording device in the one direction and a displacement amount of the relative displacement of said recording device in the another direction, which is performed subsequent to the relative displacement of said recording device in the one direction, is a predetermined ratio or less.

26. A reproducing apparatus comprising:
a reproducing device for reproducing record information recorded in a recording medium;
a displacing device for relatively displacing said reproducing device with respect to the recording medium, in one direction and another direction different from the one direction; and
a controlling device for controlling said displacing device such that a relative displacement direction of said reproducing device due to the reproduction of the record information is distributed substantially uniformly in both the one direction and the another direction.

27. A reproducing apparatus comprising:
a reproducing device for reproducing record information recorded in a recording medium;
a displacing device for relatively displacing said reproducing device with respect to the recording medium, in one direction and another direction different from the one direction; and
a controlling device for controlling said displacing device such that relative displacement of said reproducing device in the one direction and relative displacement of said reproducing device in the another direction are performed alternately and such that a ratio between a displacement amount of the relative displacement of said reproducing device in the one direction and a displacement amount of the relative displacement of said reproducing device in the another direction, which is performed subsequent to the relative displacement of said reproducing device in the one direction, is a predetermined ratio or less.

28. A reproducing method in a reproducing apparatus comprising: a reproducing device for reproducing record information recorded in a recording medium; and a displacing device for relatively displacing said reproducing device with respect to the recording medium, in one direction and another direction different from the one direction, said reproducing method comprising:
a first controlling process of controlling said displacing device such that a relative displacement direction of said reproducing device due to the reproduction of the record information is distributed substantially uniformly in both the one direction and the another direction; and
a second controlling process of controlling said reproducing device to reproduce the record information recorded in the recording medium

29. A reproducing method in a reproducing apparatus comprising: a reproducing device for reproducing record information recorded in a recording medium; and a displacing device for relatively displacing said reproducing device with respect to the recording medium, in one direction and another direction different from the one direction, said reproducing method comprising:
a first controlling process of controlling said displacing device such that relative displacement of said reproducing device in the one direction and relative displacement of said reproducing device in the another direction are performed alternately; and
a second controlling process of controlling said displacing device such that a ratio between a displacement amount of the relative displacement of said reproducing device in the one direction and a displacement amount of the relative displacement of said reproducing device in the another direction, which is performed subsequent to the relative displacement of said reproducing device in the one direction, is a predetermined ratio or less.

30. A computer program product in a computer-readable medium for tangibly embodying a program of instructions executable by a computer provided in a recording apparatus, the computer program making the computer function as a controlling device,
said recording apparatus comprising:
a recording device for recording record information into a recording medium;
a displacing device for relatively displacing said recording device with respect to the recording medium, in one direction and another direction different from the one direction; and
said controlling device for controlling said displacing device such that a relative displacement direction of said recording device due to the recording of the record information is distributed substantially uniformly in both the one direction and the another direction.

31. A computer program product in a computer-readable medium for tangibly embodying a program of instructions executable by a computer provided in a recording apparatus, the computer program making the computer function as a controlling device,
said recording apparatus comprising:
a recording device for recording record information into a recording medium;
a displacing device for relatively displacing said recording device with respect to the recording medium, in one direction and another direction different from the one direction; and
said controlling device for controlling said displacing device such that relative displacement of said recording device in the one direction and relative displacement of said recording device in the another direction are performed alternately and such that a ratio between a displacement amount of the relative displacement of said recording device in the one direction and a displacement amount of the relative displacement of said recording device in the another direction, which is performed subsequent to the relative displacement of said recording device in the one direction, is a predetermined ratio or less.

32. A computer program product in a computer-readable medium for tangibly embodying a program of instructions executable by a computer provided in a reproducing apparatus according to claim, the computer program making the computer function as a controlling device,
said reproducing apparatus comprising:
a reproducing device for reproducing record information recorded in a recording medium;
a displacing device for relatively displacing said reproducing device with respect to the recording medium, in one direction and another direction different from the one direction; and
said controlling device for controlling said displacing device such that a relative displacement direction of said reproducing device due to the reproduction of the record information is distributed substantially uniformly in both the one direction and the another direction.

33. A computer program product in a computer-readable medium for tangibly embodying a program of instructions executable by a computer provided in a reproducing apparatus according to claim, the computer program making the computer function as a controlling device,
said reproducing apparatus comprising:
a reproducing device for reproducing record information recorded in a recording medium;
a displacing device for relatively displacing said reproducing device with respect to the recording medium, in one direction and another direction different from the one direction; and
said controlling device for controlling said displacing device such that relative displacement of said reproducing device in the one direction and relative displacement of said reproducing device in the another direction are performed alternately and such that a ratio between a displacement amount of the relative displacement of said reproducing device in the one direction and a displacement amount of the relative displacement of said reproducing device in the another direction, which is performed subsequent to the relative displacement of said reproducing device in the one direction, is a predetermined ratio or less.
